(19) United States
(12) Patent Application Publication
(10) Pub. No.: US 2007/0049334 A1
(43) Pub. Date: Mar. 1, 2007

(54) Electronic apparatus and method for automatically selecting communication settings

(76) Inventor: Satori Otsuka, Yokohama-city (JP)

Correspondence Address: BRINKS HOFER GILSON & LIONE, P.O. BOX 10395, CHICAGO, IL, 60610, US

(21) Appl. No.: 11/510,283

(22) Filed: Aug. 25, 2006

(30) Foreign Application Priority Data
Aug. 26, 2005 (JP) 2005-246871

(51) Int. Cl. H04M 1/00

(52) U.S. Cl. 455/556.1

(57) ABSTRACT

An electronic apparatus is connected to a mobile communication terminal such that the electronic apparatus can perform data communications with the mobile communication terminal. The electronic apparatus includes an information obtaining unit that obtains information from the connected mobile communication terminal, and a network determining unit that subsequently determines a mobile communication network corresponding to the mobile communication terminal on the basis of the information obtained.

### BACKGROUND OF THE INVENTION

1. Field of the Invention

The present invention relates to an electronic apparatus and a method for automatically selecting communication settings for accessing mobile communication networks for data communications.

2. Description of the Related Art

Recently, electronic apparatuses that perform data communications with mobile communication terminals such as cellular phones have become available. Such electronic apparatuses can access the Internet network via, for example, cellular phones to obtain necessary information. For example, an electronic apparatus can access the Internet network via a general telephone line through a dial-up connection to an Internet service provider (ISP). When a user establishes a connection to an ISP, the user needs to configure communication settings for an electronic apparatus to connect to the ISP.

When a plurality of electronic apparatuses exist, the user may need to configure communication settings for each electronic apparatus. Configuring communication settings is a very cumbersome operation that is difficult to understand.

In view of such a problem, the following technique is proposed in Japanese Unexamined Patent Application Publication No. 2002-290509. In a communication system for electronic apparatuses proposed in this document, when any one of a plurality of electronic apparatuses has sent a read request for communication settings information, a mobile radio communication device reads communication settings information corresponding to the electronic apparatus from a memory included in the mobile radio communication device and sends the information to the electronic apparatus. Then, when a connection request for a connection target has been sent from the electronic apparatus, the mobile radio communication device establishes a communication line between the electronic apparatus and the connection target by means of a radio unit. In this arrangement, communication settings can be readily configured for each electronic apparatus.

On the other hand, mobile communication networks that allow access to the Internet network by routes that do not pass through general telephone lines are provided by carriers (mobile network operators). An electronic apparatus to which a cellular phone is connected can also access the Internet network through a dial-up connection to an access point installed in such mobile communication networks.

A plurality of carriers exist and provide unique mobile communication networks. In this environment, communication settings required for accessing individual mobile communication networks for data communications vary with the carriers. Moreover, even when certain mobile communication networks are provided by one carrier, the available mobile communication network varies with the generation of a cellular phone. Accordingly, the required communication settings also vary. That is to say, communication settings required for accessing individual mobile communication networks vary. On the other hand, an available mobile communication network is predetermined for a cellular phone. Thus, when a user connects a cellular phone to an electronic apparatus for the first time, the user needs to configure communication settings corresponding to the type of the connected cellular phone. Moreover, when the user subsequently changes the connected cellular phone, and consequently, when the available mobile communication network changes, the user needs to configure communication settings in a similar way.

Accordingly, in general electronic apparatuses, in many cases, different types of communication settings are prepared for individual mobile communication networks in advance. In this case, the user merely needs to select a desired type of communication settings from prepared types of communication settings and thus need not configure communication settings in detail. However, even in this case, the user needs to select a desired type of communication settings from prepared types of communication settings. Moreover, communication settings required for an electronic apparatus to access a mobile communication network depend on the corresponding cellular phone and not the electronic apparatus. Thus, in the communication system for electronic apparatuses proposed in Japanese Unexamined Patent Application Publication No. 2002-290509, communication settings required for accessing mobile communication networks cannot be readily configured.

### SUMMARY OF THE INVENTION

In view of the aforementioned problem, it is an object of the present invention to provide an electronic apparatus and a method for automatically selecting communication settings required for accessing a mobile communication network for data communications.

An electronic apparatus according to the present invention is connected to a mobile communication terminal so that the electronic apparatus can perform data communications with the mobile communication terminal, and includes an information obtaining unit operable to obtain identification information from the connected mobile communication terminal, and a network determining unit operable to determine a mobile communication network corresponding to the mobile communication terminal on the basis of the identification information obtained. In the electronic apparatus according to the present invention, the mobile communication network corresponding to the connected mobile communication terminal can be determined.

The information obtaining unit may presume a default mobile communication network corresponding to the connected mobile communication terminal and may obtain the identification information from the mobile communication terminal by sending a request command corresponding to the presumed or default mobile communication network to the mobile communication terminal.

Mobile communication network information that represents the mobile communication network may be linked to model information that represents a model of a mobile communication terminal corresponding to the mobile communication network in a first data table, and the network determining unit may determine a model of the connected mobile communication terminal on the basis of the determination information and the default mobile communication network instead of determining the mobile communication network and then may determine the mobile communication network corresponding to the connected mobile communication terminal on the basis of the determined model and the first data table. In this case, when it has been determined that the identification information that can be obtained from the presumed mobile communication network includes model information, a model can be determined, and then, the mobile communication network corresponding to the connected mobile communication terminal can be determined on the basis of the determined model.

The model information may be linked to serial number information that represents a serial number corresponding to a model represented by the model information in a second data table, and the network determining unit may determine a serial number of the connected mobile communication terminal on the basis of the identification information and the default mobile communication network, determine a model of the connected mobile communication terminal on the basis of the determined serial number and the second data table, and then determine the mobile communication network corresponding to the connected mobile communication terminal on the basis of the determined model and the first data table. In this case, when it has been determined that the identification information that can be obtained from the default mobile communication network includes serial number information, a serial number can be determined, and then, the mobile communication network corresponding to the connected mobile communication terminal can be determined on the basis of the determined serial number.

The network determining unit may include a history management unit that, for individual segments of the mobile communication network information, manages histories of determination counts, the determination counts track how often individual types of mobile communication network have been determined, and the information obtaining unit may determine a most accessed mobile communication network that has been accessed the most on the basis of the determination counts and may obtain the identification information from the connected mobile communication terminal by sending a request command corresponding to the most accessed mobile communication network to the connected mobile communication terminal. In this case, it is highly probable that the mobile communication network corresponding to the connected mobile communication terminal can be readily determined. The mobile communication network may be linked to communication settings information required for accessing the mobile communication network in a third data table, and the electronic apparatus according to the present invention may further include an automatic selecting unit that selects communication settings required for accessing the mobile communication network on the basis of the third data table and the determined mobile communication network. In this case, the electronic apparatus can automatically select communication settings without the user's operation.

The electronic apparatus according to the present invention may have navigation function. That is to say, the electronic apparatus may be implemented in the form of a navigation apparatus.

A method according to the present invention for automatically selecting communication settings includes obtaining determination information from a connected mobile communication terminal, determining a mobile communication network corresponding to the mobile communication terminal on the basis of the determination information, and selecting communication settings required for accessing the determined mobile communication network for data communications on the basis of the mobile communication network.

The present invention can provide an electronic apparatus and a method for automatically selecting communication settings required for accessing a mobile communication network for data communications.

### BRIEF DESCRIPTION OF THE DRAWINGS

FIG. 1 is a block diagram showing the structure of an exemplary electronic apparatus according to a first embodiment;

FIG. 2 shows exemplary first, second, and third data tables;

FIG. 3 is a flowchart showing exemplary control that is performed by a control unit when a cellular phone is connected to the electronic apparatus;

FIG. 4 is a flowchart showing exemplary control and model determination that are performed by the control unit in steps in the flowchart shown in FIG. 3 to obtain determination information; and

FIG. 5 shows exemplary historical management of determination counts.

### DESCRIPTION OF THE PREFERRED EMBODIMENTS

Embodiments according to the present invention will now be described in detail with reference to the drawings.

### First Embodiment

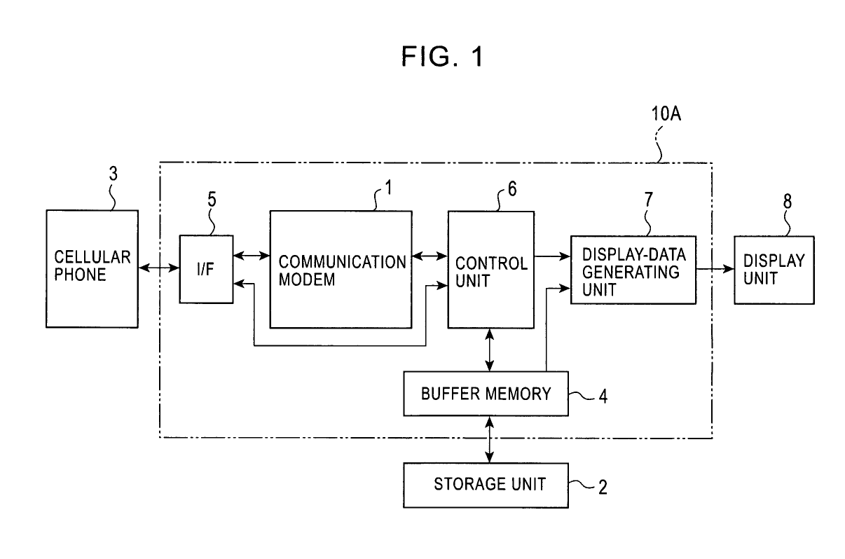

The structure of an electronic apparatus 10A according to a first embodiment will be described in detail with reference to FIG. 1. In the present embodiment, the electronic apparatus 10A may be implemented in the form of an in-vehicle navigation apparatus. However, the present embodiment is not restrictive. Alternatively, the electronic apparatus 10A may be implemented in the form of a personal computer or a television set. In FIG. 1, a communication modem 1 is configured to establish a two-way communication link between an Internet browser and an ISP connected to the Internet. That is to say, the electronic apparatus 10A has browsing function, and the communication modem 1 establishes a two-way communication link, so that the user can browse web sites on the Internet with the electronic apparatus 10A.

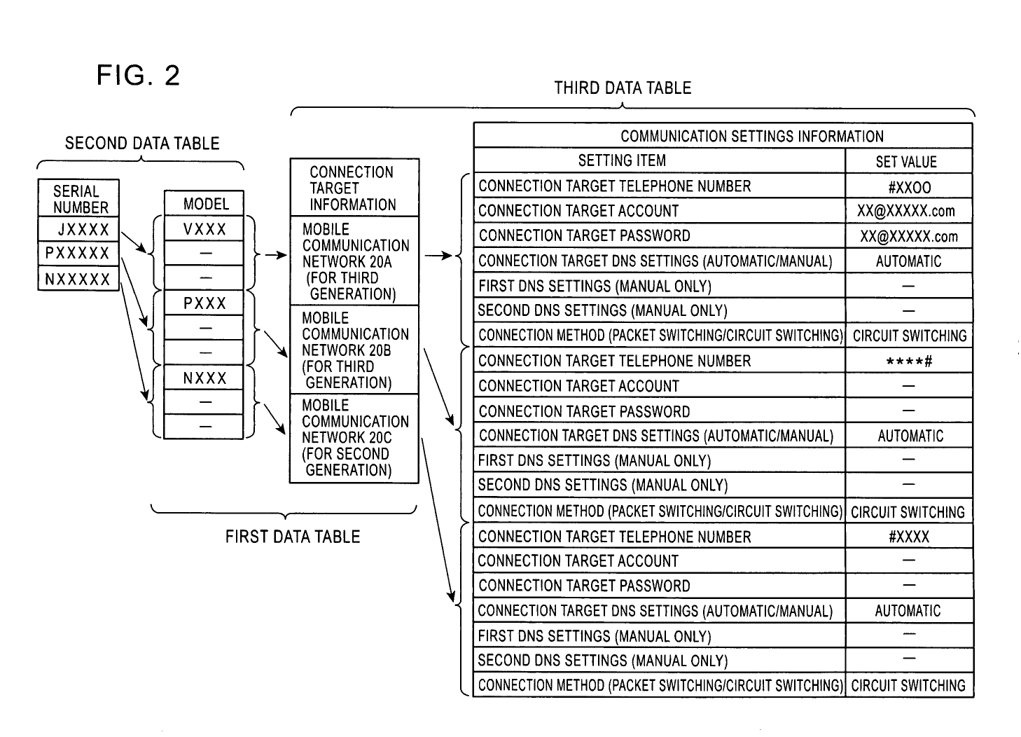

A storage unit 2 is configured to store data linked-to each other in first, second, and third data tables. For example, a hard disk drive may be used as the storage unit 2. A storage medium, for example, a compact disc-read only memory (CD-ROM) or a digital versatile disc (DVD)-ROM, maybe used instead of the storage unit 2. In this case, a reading mechanism for reading data from the storage medium is required. FIG. 2 shows the first, second, and third data tables. In the first data table, connection target information (mobile communication network information) that represents a mobile communication network 20 is linked to model information that represents the model of a cellular phone 3 that supports the mobile communication network 20, as shown in FIG. 2. In the second data table, the model information is linked to serial number information that represents a serial number corresponding to the model represented by the model information. Moreover, in the third data table, the connection target information is linked to communication settings information required for accessing the mobile communication network 20. The communication settings information includes a connection target telephone number, a connection target account, a connection target password, connection target domain name server (DNS) settings, first DNS information, second DNS information, and a connection method, as shown in FIG. 2. The storage unit 2 may also store other data.

A buffer memory 4 is configured to store data to be stored by the storage unit 2, for example, data in the first and second data tables, under the control of a control unit 6 that is described below. Data can be also stored in the storage unit 2 from a random access memory (RAM) included in the control unit 6 via the buffer memory 4 under the control of the control unit 6.

An interface (I/F) 5 is configured to connect the cellular phone 3 to an internal bus and the communication modem 1 in the electronic apparatus 10A. The I/F 5 supports connection of a third-generation cellular phone and is a universal serial bus (USB) connection terminal in the embodiments. Alternatively, the I/F 5 may be a connection terminal that supports the Personal Digital Cellular (PDC) system for connection of a second-generation cellular phone for which the PDC system is adopted. The I/F 5 is connected to the interface of the cellular phone 3 with a dedicated cable. Thus, the I/F 5 may be a connection terminal based on any other standard as long as the I/F 5 can be connected to the cellular phone 3 so that the I/F 5 can perform data communications with the cellular phone 3. Moreover, the I/F 5 may be connected to the interface of the cellular phone 3 with various types of network, for example, Bluetooth, instead of a dedicated cable. In the embodiments, when a second-generation cellular phone is connected to the I/F-5, an adapter is provided between the I/F 5 and the interface of the second-generation cellular phone. A path that extends from the I/F 5 to the internal bus is used, for example, obtaining a large amount of data such as image data that is captured with the cellular phone 3 and storing the data in the storage unit 2.

In the embodiments, the cellular phone 3 is used as a mobile communication terminal and configured to connect to an access point in the mobile communication network 20 in response to an instruction from the electronic apparatus 10A. Moreover, the cellular phone 3 receives and sends data from and to a server via the Internet network in response to an instruction from the control unit 6.

The control unit 6 includes, for example, a microcomputer or a processing unit such as a central processing unit (CPU). The control unit 6 includes the following built-in programs and performs various types of processing according to these programs. A first program is a program for obtaining from the connected cellular phone 3 identification or determination information 30 required for determining the type of the mobile communication network 20 corresponding to the cellular phone 3. Specifically, in this program, the type of the mobile communication network 20 corresponding to the connected cellular phone 3 is presumed for the cellular phone 3, and a request command corresponding to the presumed type of the mobile communication network 20 is sent to the cellular phone 3 to obtain the determination information 30 from the cellular phone 3. A second program is a program for determining the type of the mobile communication network 20 corresponding to the connected cellular phone 3 on the basis of the determination information 30.

A third program is a program for determining the model of the cellular phone 3 on the basis of the presumed type of the mobile communication network 20 and the determination information 30 and then determining the type of the mobile communication network 20 corresponding to the cellular phone 3 on the basis of the determined model and the first data table. A fourth program is a program for determining the serial number of the cellular phone 3 on the basis of the presumed type of the mobile communication network 20 and the determination information 30, determining the model of the cellular phone 3 on the basis of the determined serial number and the second data table, and then determining the type of the mobile communication network 20 corresponding to the cellular phone 3 on the basis of the determined model and the first data table. A fifth program is a program for selecting communication settings required for accessing the mobile communication network 20 for data communications on the basis of the determined type of the mobile communication network 20 and communication settings information stored-in the storage unit 2. The aforementioned programs may be stored in, for example, a CD-ROM or a DVD-ROM. In this case, the control unit 6 reads and executes the programs as necessary. In the embodiments, the control unit 6, which executes the aforementioned programs, functions as a determination-information obtaining unit, a mobile-communication-network determining unit, and an automatic communication-settings selecting unit.

The display-data generating unit 7 is configured to obtain data from the buffer memory 4 or the RAM according to an instruction from the control unit 6 and generate data to be displayed by the display unit 8. The display unit 8 is configured to display the display data generated by the display-data generating unit 7.

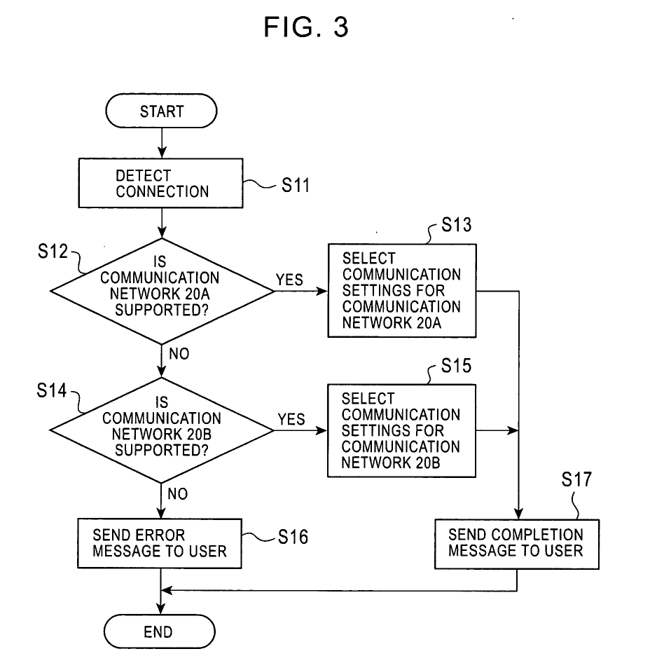

The control performed by the control unit 6 in the aforementioned structure will now be described in detail with an example. FIG. 3 is a flowchart showing exemplary control that is performed by the control unit 6 when the cellular phone 3 is connected to the electronic apparatus 10A. The flowchart in FIG. 3 shows a case where a third-generation cellular phone is connected to the electronic apparatus 10A. In step S11, the control unit 6 first detects that a cellular phone 3X has been connected to the I/F 5. In this example, when the corresponding mobile communication network 20 is not clear, the cellular phone 3 is referred to as the cellular phone 3X. When the corresponding mobile communication network 20 is a mobile communication network 20A, the cellular phone 3 is referred to as a cellular phone 3A. When the corresponding mobile communication network 20 is a mobile communication network 20B, the cellular phone 3 is referred to as a cellular phone 3B. The determination information 30 is treated in a similar way. After the control unit 6 obtains determination information 30A from the cellular phone 3X, the control unit 6 determines the model in step S12, assuming that the connected cellular phone 3X is the cellular phone 3A, which supports the mobile communication network 20A. When the control unit 6 has determined that the model supports the communication network 20A as the result of model determination, the control unit 6 selects communication settings corresponding to the mobile communication network 20A on the basis of information in the third data table in step S13.

When the connected cellular phone 3X does not support the communication network 20A, the control unit 6 determines that the model does not support the communication network 20A, obtains determination information 30B from the cellular phone 3X, and then determines the model in step S14, assuming that the communication network 20B is supported. When the control unit 6 has determined that the model supports the communication network 20B, the control unit 6 selects communication settings corresponding to the mobile communication network 20B on basis of information in the third data table in step S15. When the model does not support the communication network 20B, after the control unit 6 obtains the determination information 30 from the cellular phone 3X, the control unit 6 determines the model in a similar way, assuming that all types of the third-generation mobile communication network 20 shown in the connection target information stored in the storage unit 2 are supported. However, in this example, the model is determined, assuming that the communication networks 20A and 20B are all types of third-generation communication network for the sake of the illustration.

When the control unit 6 has determined in step S14 that the model does not support the communication network 20B, in step S16, the control unit 6 sends the user a message stating that model determination has been failed. When communication settings have been selected in step S13 or S15, in step S17, the control unit 6 sends the user a message stating that communication settings have been completed. For example, the control unit 6 causes the display-data generating unit 7 to generate information to displayed, the information stating that model determination has been failed or that communication settings have been completed, and sends the user the generated information through the display unit 8. When communication settings are failed, a possible cause is, for example, a poor connection or malfunction of the cellular phone 3X or that the model of the cellular phone 3X is not supported.

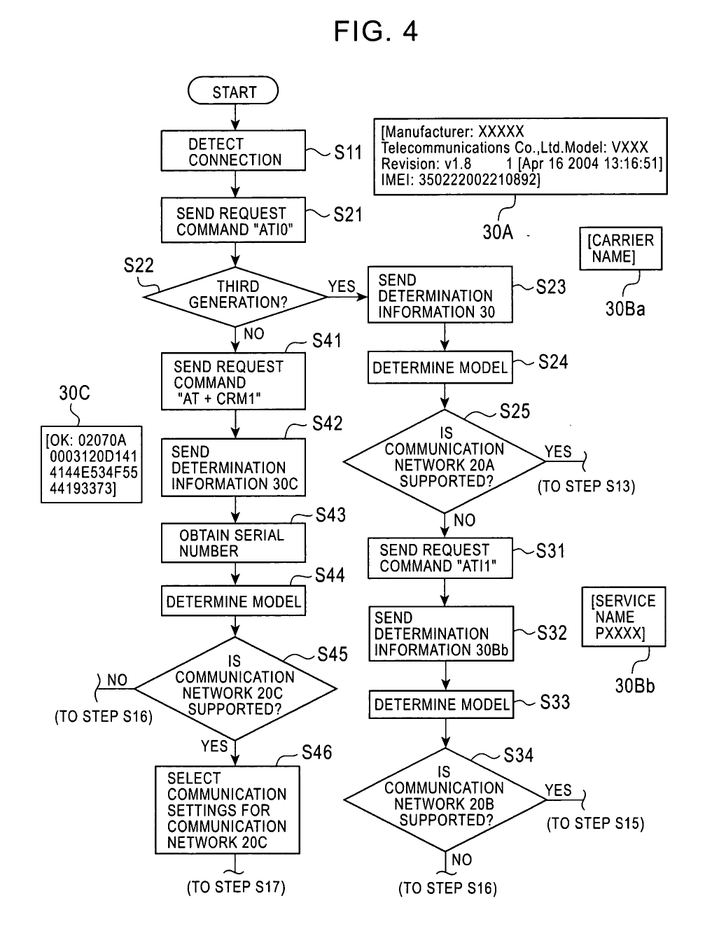

The details of exemplary control and model determination performed by the control unit 6 for obtaining the determination information 30 in steps S12 and S14 in the flowchart shown in FIG. 3 will now be described with reference to a flowchart shown in FIG. 4. A case where a second-generation cellular phone is connected to the electronic apparatus 10A is also described in the flowchart shown in FIG. 4. The control unit 6 detects connection of the cellular phone 3X in step S11 and sends a request command “ATI0” to a modem port of the cellular phone 3X in step S21 to obtain the determination information 30. The request command “ATI0” is a command for obtaining the determination information 30 from the cellular phone 3X assuming that the cellular phone 3X is a third-generation cellular phone and supports the communication network 20A. In step S22, the control unit 6 determines whether the cellular phone 3X is a third-generation cellular phone. When the cellular phone 3X is a third-generation cellular phone, the cellular phone 3X sends the determination information 30 in step S23. When the cellular phone 3X is not a third-generation cellular phone, the determination information 30 cannot be obtained because the request command “ATI0” sent in step S21 does not support a second-generation cellular phone. It may be determined by checking the connection status when the cellular phone 3X is connected whether the cellular phone 3X is a second-generation cellular phone or a third-generation cellular phone.

When the cellular phone 3X supports the mobile communication network 20A, the cellular phone 3X sends the determination information 30A in step S23. The determination information 30A is text data, as shown in the drawing. Then, in step S24, the control unit 6 performs model determination, assuming that the communication network 20A is supported. In this model determination, it is determined whether the determination information 30A includes model information. As the result of model determination, the control unit 6 determines that the determination information 30A includes the model information of a model VXXX. Then, in step S25, the control unit 6 determines, on the basis of information in the first data table, whether the model VXXX supports the mobile communication network 20A. The control in steps S21 to S25 shows the details of model determination that is performed in step S13 in the flowchart shown in FIG. 3.

In steps S21 to S25, it is assumed that the cellular phone 3X supports the mobile communication network 20A. A case where the cellular phone 3X supports the mobile communication network 20B will now be described in detail. The cellular phone 3B is a third-generation cellular phone. In this case, the cellular phone 3X sends determination information 30Ba in step S23. The determination information 30Ba is text data that includes a carrier name, as shown in the drawing. That is to say, when the request command “ATI0” is sent, data that represents a carrier name is obtained from the cellular phone 3X (3B) as the determination information 30Ba. Thus, the model of the cellular phone 3X cannot be determined on the basis of the determination information 30Ba. Accordingly, when the cellular phone 3X is assumed to support the communication network 20B, the control unit 6 sends a request command “ATI1” to the modem port of the cellular phone 3X to obtain determination information 30Bb in step S31 after step S25. In step S32, the cellular phone 3X sends the determination information 30Bb in response to the request command “ATI1”.

The determination information 30Bb is text data that includes “service name: PXXX”, as shown in the drawing. PXXX denotes a model. In step S33, the control unit 6, which has obtained the determination information 30Bb, performs model determination, assuming that the communication network 20B is supported. In this model determination, it is determined whether the determination information 30Bb includes model information. When it has been determined that the determination information 30Bb includes the model information of a model PXXX, as the result of model determination, the control unit 6 determines in step S34, on the basis of information in the first data table, whether the model PXXX supports the mobile communication network 20B. The control in steps S31 to S34 shows the details of model determination that is performed in step S15 in the flowchart shown in FIG. 3. The service name represents the name of a mobile network service that provides access to the mobile communication network 20B. Thus, service names may be stored in the storage unit 2, and the control unit 6 may determine a service name instead of a model in step S33 and then determine a supported type of the mobile communication network 20 on the basis of the service name.

In steps S21 to S34, it is assumed that the cellular phone 3X supports the mobile communication network 20A or 20B. A case where the cellular phone 3X supports a mobile communication network 20C will now be described in detail. A cellular phone 3C is a second-generation cellular phone, and the PDC system is adopted for the cellular phone 3C. In this case, in step S22, the control unit 6 determines that the cellular phone 3X is not a third-generation cellular phone because, for example, the determination information 30 has not been obtained within a predetermined period of time. When the cellular phone 3X is assumed to support the communication network 20C, the control unit 6 sends a request command “AT+CRM1” to the cellular phone 3X via the communication modem 1 in step S41. In step S42, the cellular phone 3X (3C) sends determination information 30C in response to the request command “AT+CRM1”. The determination information 30C is data shown in the drawing and needs to be analyzed. In step S43, the control unit 6 performs data analysis on the determination information 30C after obtaining the determination information 30C to obtain a serial number NXXXXX from the analyzed data.

In step S44, the control unit 6 performs model determination on the basis of the obtained serial number NXXXXX and serial numbers registered in the second data table, assuming that the communication network 20C is supported. Specifically, the control unit 6 determines a model corresponding to the serial number NXXXXX on the basis of information in the second data table. When the control unit 6 has determined that a model NXXX corresponds to the serial number NXXXXX, as the result of model determination, the control unit 6 determines in step S45, on the basis of information in the first data table, whether the model NXXX supports the mobile communication network 20C. The control in steps S41 to S45 shows the details of control and model determination that are performed by the control unit 6 to obtain the determination information 30C when the connected cellular phone 3X is a second-generation cellular phone.

When it has been determined in step S45 that the communication network 20C is supported, the control unit 6 selects communication settings corresponding to the communication network 20C in step S46. When it has been determined that the communication network 20C is not supported, after the control unit 6 obtains the determination information 30 from the cellular phone 3X, the control unit 6 determines the model in a similar way, assuming that all types of the second-generation mobile communication network 20 shown in the connection target information stored in the storage unit 2 are supported. However, in this example, the model is determined, assuming that the communication network 20C is the only type of second-generation communication network for the sake of the illustration. Thus, when the communication network 20C is not supported, the control unit 6 performs control in step S16 in the flowchart shown in FIG. 3. In the first embodiment, the electronic apparatus 10A and the method can be implemented, in which communication settings for accessing the mobile communication network 20 for data communications are automatically selected.

### Second Embodiment

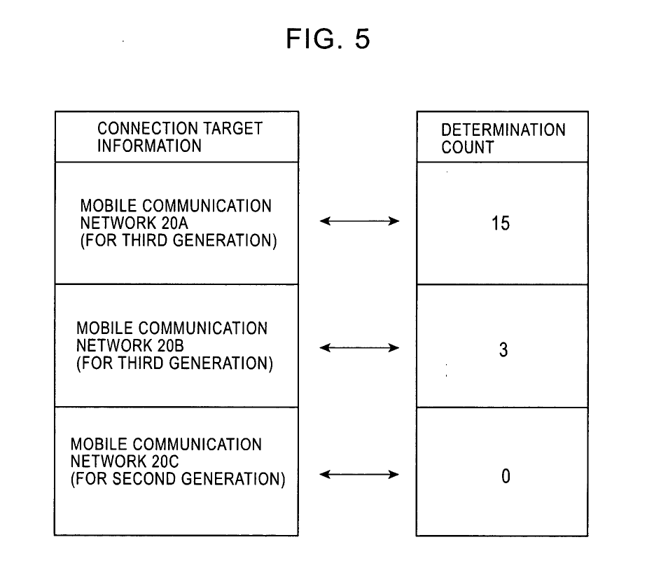

The structure of an electronic apparatus 10B according to a second embodiment is the same as that of the electronic apparatus 10A according to the first embodiment. However, the control unit 6 in the electronic apparatus 10B according to the second embodiment includes the following built-in programs in addition to the programs stored in the control unit 6 in the electronic apparatus 10A according to the first embodiment. A sixth program is a program for managing histories of determination counts of how often individual types of the mobile communication network 20 have been determined for individual segments of connection target information. FIG. 5 shows exemplary historical management of determination counts. The information of determination counts can be stored in, for example, a data table shown in FIG. 5 in the storage unit 2 for individual segments of connection target information. When the control unit 6 has determined a type of the mobile communication network 20, the control unit 6 reads the determination count of the type of the mobile communication network 20, adds one to the read determination count, and stores the result in the storage unit 2 as an updated determination count. In this way, the control unit 6 manages histories of determination counts. That is to say, in the present embodiment, the control unit 6 functions as a history management unit.

A seventh program is a program for determining the type of the mobile communication network 20 that has been most accessed on the basis of determination counts stored in the storage unit 2. An eighth program is a program for performing control instead of the control process in the aforementioned step S21. In the eighth program, when the cellular phone 3X has been connected, assuming that the cellular phone 3X supports the type of the communication network 20 that has been most accessed, a request command corresponding to the type of the communication network 20 is sent to the cellular phone 3X. It is highly probable that the type of the mobile communication network 20 corresponding to the cellular phone 3X can be readily determined by executing the eighth program. Steps S22 to S25, steps S32 to S34, or steps S42 to S45 according to the first embodiment in the flowchart shown in FIG. 4 are executed after the eighth program is executed. When model determination has not been successfully completed in these steps, the control unit 6 sequentially performs control shown in the flowchart in FIG. 4 from step S21. In this case, the same steps as the step that has been executed by the control unit 6 assuming that the type of the communication network 20 that has been most accessed is supported can be omitted. In the second embodiment, the electronic apparatus 10B and the method can be implemented, in which communication settings for accessing the mobile communication network 20 for data communications are automatically selected.

The information of the first and second data tables and communication settings information corresponding to all available types of the mobile communication network 20 stored in the storage unit 2 may be stored in a server that can be accessed from the cellular phone 3 via the Internet network. In this case, a company that provides the electronic apparatus 10A or 10B may manage the information stored in the server and update the information with the latest information, for example, when the communication settings information has been changed. In this arrangement, the electronic apparatuses 10A and 10B and the method can be implemented, in which communication settings for accessing the mobile communication network 20 for data communications are automatically selected on the basis of the latest information.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. An electronic apparatus that is connected to a mobile communication terminal, the electronic apparatus being operable to perform data communications with the mobile communication terminal, the electronic apparatus comprising:
an information obtaining unit operable to obtain identification information from the connected mobile communication terminal; and
a network determining unit operable to determine a mobile communication network corresponding to the mobile communication terminal on the basis of the identification information.

2. The electronic apparatus according to claim 1, wherein the information obtaining unit is operable to select a default mobile communication network corresponding to the mobile communication terminal and obtain the identification information from the mobile communication terminal by sending a request command corresponding to the default mobile communication network to the mobile communication terminal.

3. The electronic apparatus according to claim 2, wherein mobile communication network information is linked to model information in a first data table, the communication network information represents the mobile communication network and the model information represents a model of a mobile communication terminal corresponding to the mobile communication network, and
the network determining unit is operable to determine (1) a model of the connected mobile communication terminal on the basis of the identification information and the default mobile communication network, and then (2) the mobile communication network corresponding to the connected mobile communication terminal on the basis of the determined model and the first data table.

4. The electronic apparatus according to claim 3, wherein the network determining unit includes a history management unit that, for individual segments of the mobile communication network information, is operable to manage histories of determination counts, the determination counts track how often individual types of mobile communication networks have been determined, and
the information obtaining unit is operable to (1) determine a most accessed mobile communication network that has been accessed the most on the basis of the determination counts and (2) obtain the identification information from the connected mobile communication terminal by sending a request command corresponding to the most accessed mobile communication network to the connected mobile communication terminal.

5. The electronic apparatus according to claim 3, wherein the model information is linked to serial number information in a second data table, the serial number information represents a serial number corresponding to a model represented by the model information, and
the network determining unit is operable to determine (1) a serial number of the connected mobile communication terminal on the basis of the identification information and the default mobile communication network, (2) a model of the connected mobile communication terminal on the basis of the determined serial number and the second data table, and then (3) the mobile communication network corresponding to the connected mobile communication terminal on the basis of the determined model and the first data table.

6. The electronic apparatus according to claim 1, wherein the mobile communication network is linked to communication settings information in a third data table, the communication settings information being required for accessing the mobile communication network,
further comprising an automatic selecting unit operable to select communication settings required for accessing the mobile communication network on the basis of the third data table and the determined mobile communication network.

7. The electronic apparatus according to claim 1, wherein the electronic apparatus is operable to perform a navigation function.

8. The electronic apparatus according to claim 1, wherein mobile communication network information that represents the mobile communication network is linked to model information in a first data table, the communication network information represents the mobile communication network and the model information represents a model of a mobile communication terminal corresponding to the mobile communication network, and
the network determining unit is operable to determine a mobile communication network corresponding to the connected mobile communication terminal on the basis of the first data table.

9. The electronic apparatus according to claim 8, wherein the model information is linked to serial number information in a second data table, the serial number information represents a serial number corresponding to a model represented by the model information, and
the network determining unit is operable to determine (1) a model of the connected mobile communication terminal on the basis of the determined serial number and the second data table, and then (2) the mobile communication network corresponding to the connected mobile communication terminal on the basis of the determined model and the first data table.

10. An electronic apparatus that is connected to a mobile communication terminal, the electronic apparatus being operable to perform data communications with the mobile communication terminal, the electronic apparatus comprising:
an information obtaining unit operable to determine a default mobile communication network corresponding to the connected mobile communication terminal and obtain identification information from the mobile communication terminal by sending a request command corresponding to the default mobile communication network to the mobile communication terminal; and
a network determining unit operable to determine (1) a model of the mobile communication terminal on the basis of the identification information and the default mobile communication network and then (2) the mobile communication network corresponding to the mobile communication terminal on the basis of the determined model and a first data table in which mobile communication network information that represents the mobile communication network is linked to model information, the model information represents a model of a mobile communication terminal corresponding to the mobile communication network.

11. The electronic apparatus according to claim 10, wherein the network determining unit includes a history management unit that, for individual segments of the mobile communication network information, manages histories of determination counts, the determination counts track how often individual types of mobile communication networks have been determined, and
the information obtaining unit is operable to (1) determine a most accessed mobile communication network that has been accessed the most on the basis of the determination counts and (2) obtain the identification information from the connected mobile communication terminal by sending a request command corresponding to the most accessed mobile communication network to the connected mobile communication terminal.

12. The electronic apparatus according to claim 10, wherein the mobile communication network is linked to communication settings information in a third data table, the communication settings information being required for accessing the mobile communication network,
further comprising an automatic selecting unit operable to select communication settings required for accessing the mobile communication network on the basis of the third data table and the determined mobile communication network.

13. The electronic apparatus according to claim 10, wherein the electronic apparatus is operable to perform a navigation function.

14. A method for automatically selecting communication settings, the method comprising:
obtaining information from a connected mobile communication terminal, the information identifying a type of mobile communication terminal;
determining a mobile communication network corresponding to the mobile communication terminal on the basis of the information obtained; and
selecting communication settings required for accessing the determined mobile communication network on the basis of the mobile communication network.

15. The method according to claim 14, the method further comprising presuming a mobile communication network corresponding to the mobile communication terminal, wherein the information is obtained from the mobile communication terminal by sending a request command corresponding to the presumed mobile communication network to the mobile communication terminal.

16. The method according to claim 14, the method further comprising:
linking mobile communication network information to model information in a first data table, the mobile communication network information represents the mobile communication network and the model information represents a model of a mobile communication terminal corresponding to the mobile communication network;
determining a model of the connected mobile communication terminal on the basis of the information obtained and the presumed mobile communication network; and
determining the mobile communication network corresponding to the connected mobile communication terminal on the basis of the determined model and the first data table.

17. The method according to claim 14, the method further comprising:
managing histories of determination counts for individual segments of the mobile communication network information, the determination counts track how often individual types of mobile communication networks have been determined; and
determining a most accessed mobile communication network that has been accessed the most on the basis of the determination counts, and the information is obtained from the connected mobile communication terminal by sending a request command corresponding to the most accessed mobile communication network to the connected mobile communication terminal.

18. The method according to claim 14, the method further comprising:
linking the model information to serial number information in a second data table, the serial number information represents a serial number corresponding to a model represented by the model information;
determining a serial number of the connected mobile communication terminal on the basis of the information obtained and the presumed mobile communication network; and
determining a model of the connected mobile communication terminal on the basis of the determined serial number and the second data table.

19. The method of claim 18, the method further comprising determining the mobile communication network corresponding to the connected mobile communication terminal on the basis of the determined model and the first data table.

20. The method according to claim 14, the method further comprising performing a navigation function.
